(19) United States
(12) Patent Application Publication
(10) Pub. No.: US 2002/0096803 A1
(43) Pub. Date: Jul. 25, 2002

(54) Process and apparatus for shaping and processing pieces of material

(76) Inventor: Manuel Burger, Nesselwang (DE)

Correspondence Address: COLLARD & ROE, P.C., 1077 Northern Boulevard, Roslyn, NY, 11576-1696, US

(21) Appl. No.: 10/022,092

(22) Filed: Dec. 17, 2001

(30) Foreign Application Priority Data
Dec. 17, 2000 (DE) 100 62 828.1

(51) Int. Cl. B29C 53/08; B29C 53/84

(52) U.S. Cl. 264/339; 264/492; 264/345; 264/348; 425/393; 425/403.1

(57) ABSTRACT

A process and a device for shaping and processing pipes. The device contains a carriage assembly and a plurality of bending units. The process includes the steps of moving a plurality of bending units freely along the pipes and performing a plurality of simultaneous bending operations using the adjustable bending units on the pipes. This process can also include the steps of engaging two end sections of the pipes using one of the plurality of bending units and applying at least one additional bending unit to the pipe corresponding to a number of further bending operations planned. With the device, there can also be a plurality of tracks to guide the carriage assembly. In addition the bending units can also comprise robots for shaping the pipes. These pipes can be heated before, during or after they are bent.

### BACKGROUND OF THE INVENTION

1. Field of the Invention

The present invention relates to a process and device for shaping and processing pieces of material, particularly pipes, with adjustable bending units.

2. The Prior Art

Several bending units that can be used to produce complicated bent parts have already been disclosed in practical operation. However, the bending process is comparatively time-consuming, because the individual bending operations are performed in succession.

### SUMMARY OF THE INVENTION

It is an object of the present invention to propose a process which can perform complicated shaping operations in an efficient manner.

The individual bending units can move freely and carry out bending operations on the piece of material at approximately the same time.

The piece of material is grabbed by all the bending units at almost exactly the same time and all the bending operations can be performed freely on a three-dimensional basis at the same time.

The process can also include a bending unit that engages each of the two end sections of the piece of material in question. In addition, a number of bending units corresponding to the number of additional bending operations planned, engages the piece of material in the section in-between.

The number of bending units can be chosen in this context to correspond to the maximum number of bending operations planned. In addition, the number of bending units required to complete the necessary bending operations is then deployed in each case.

In addition, the process can also include a step of moving the outer bending units towards each other longitudinally at the same time that the inner bending units move apart from each other laterally.

As a result, the bending operations can be performed in an exact manner and there is no danger of any undesirable stretching of the material.

The bending units can also have profiled rollers wherein the piece of material that is to be bent engages the profiling in the bending operation.

If the profiling of the rollers corresponds to the diameter of the piece of material, the cross-section of the material does not change in the bending area. In addition, it is best to provide profiled double rollers between which the piece of material that requires bending is placed.

This means that the entire circumference of the piece of material is guided in the bending area, so that no deformation of the cross-section can occur. In addition, the device also includes at least two outer bending units having gripping pliers.

Furthermore, the ends of the piece of material are held securely in place by the gripping pliers during the bending operation. These gripping pliers may also be profiled.

Furthermore, there can also be sealing nipples pressed axially into the two end sections of the pieces of pipe-shaped material that are held by the bending units and/or gripping pliers. These sealing nipples are deployed when the bent pipe sections are used later on and can also be used during the bending operation.

Furthermore, the end sections are expanded by about 45□ and/or flanged when mandrels or sealing nipples are pressed into these end sections. Thus, there occurs a tight fit and very effective sealing due to the stresses created in the piece of material.

This piece of material made of plastic can be heated before the bending operation, or during the bending operation. However, the piece of material can be heated after all the bending operations have occurred. If this is done, the stresses created in the piece of material during cold bending are eliminated.

It is also possible to combine the heating operations before and after the bending operations. This heating can occur in the thermoelastic range of the plastic used. The heating process can use radiation heat such as infrared radiation, steam, hot air, or pressurized hot air.

This material can then be cooled by forcing cold water through pipes after the bending and heating operations have been completed.

Thus, there is created a three-dimensional shape of the piece of material in the bending operation.

The piece of material is cooled very quickly in its finalised shape. Furthermore, the pipe section is pressurised internally during the bending operation.

This pressurization maintains the cross-section of the piece of pipe-shaped material during the bending operation. In addition, the cross-section of the pipe section can be stabilised via an insertion of a flexible core. This core makes sure that the walls do not collapse during the bending operation and can simply be pulled out after the bending operation has been completed.

The bending or shaping units rest on carriage assemblies and are designed to be mobile. This means that the units can move to whatever position is required. Furthermore, the carriage assemblies have at least two adjacent tracks. It is also possible to have the bending units move past each other too. The bending units have a plurality of bending cores that have different bending radiuses and/or different groove sizes. It is also possible to use the appropriate bending core in each case, which makes the apparatus very flexible.

Furthermore, the core required is selected fully automatically and the bending cores can be replaced—also fully automatically—if a suitable bending core is not available. To make this possible, the processing or bending units are designed as robots, which are capable of removing the tool that is needed at any time from a magazine.

There is a control unit wherein there are bending parameters of the bending units and the bending unit=s bending movements are controlled. This design can create a large number of bends on comparatively long plastic pipes. In addition, this design can also create a smaller number of bends on shorter pipes.

The apparatus can bend these metal pipes; in this context using a bending finger that positions the pipe closely against the bending core along the proposed curve section. Furthermore, there can be not only individual processing units, but also a plurality of groups of bending units that can be actuated to process a plurality of pipe sections at the same time wherein all the processing units can be actuated to process one single pipe section approximately at the same time.

A heating section and a separating unit are provided for the plastic pipe, wherein there is a transport carriage located after the separating unit.

The transport carriage can be configured as a tandem transport carriage with two supports for the pipe section that is to be transported and is preferably CNC-controlled. The transport carriage can also have heat insulation facilities, to avoid cooling the heated pipe sections that have to be transported.

Moreover, the transport carriage can move to one or more take-over positions. This depends on whether a long pipe section is shaped to require almost the entire apparatus or whether several short pipe sections are involved that are only subjected to a few bending operations.

The gripping tools can be designed to be heat-insulated, coolable or heatable. The shaping tools (robots) are configured to be transfer units, which are in a position to pass the pipe section on to a buffer or transport system once the shaping process has been completed. The processing stations (robots) can have double bending units. Two possibly different bending operations can then be performed simultaneously at one processing station.

These double bending units are a preferably variable distance away from each other wherein these two bending units are located so that they can be swivelled in relation to each other.

An appropriate apparatus for shaping plastic pipes includes an infeed apparatus that is followed by a heating section. Infrared radiation heaters are located in this heating section. A separating unit, in which pipe sections of the required length are separated, is located at the end of the heating section.

The subsequent tandem transport carriage is CNC-controlled, and takes hold of the pipe section at two places and transports it to the planned take-over position. The transport carriage has heat insulation facilities to make sure that the pipe section does not cool down during the transport operation. When the take-over position has been reached, the end sections of the pipe are taken hold of by two sets of gripping pliers and are then expanded by 45□. This is done with appropriate mandrels that are pressed axially into the ends of the pipe section. Sealing nipples are then inserted in these expanded ends. The expansion operation can also be performed directly when the sealing nipples are inserted.

Bending units between the two sets of gripping pliers engage the pipe section according to the number of planned bending operations. All the operations to bend the pipe section occur at the same time, with the bending units moving freely on a three-dimensional basis to do this. The two sets of gripping pliers move towards each other while this is being done to avoid undesirable stretching of the plastic material.

The gripping pliers and the bending units are designed as robots. These robots can move freely on a three-dimensional basis and can remove the necessary tools independently from relevant magazines. These robots are located on carriage assemblies so that they can move freely on three parallel tracks. All the tools are heatable, coolable and heat-insulated, so that optimum implementation of the shaping operations can be controlled.

When the shaping process has been completed, the plastic pipe is cooled, so that the bends that have been made are finalised completely. The finished structure is then passed on by the robots to a transport system, with the possible provision of an intermediate buffer facility. It is possible to equip the robots with double bending units. Thus, the number of possible bending operations is doubled. Depending on the requirements, all the tools can be used at the same time to shape a pipe section.

With shorter pipe sections that require fewer bending operations, several pipe sections can on the other hand be supplied by the transport carriage that can then be shaped at almost exactly the same time. It is also perfectly possible for these pipe sections to have different designs too.

### BRIEF DESCRIPTION OF THE DRAWINGS

Other objects and features of the present invention will become apparent from the following detailed description considered in connection with the accompanying drawings which disclose one embodiment of the present invention. It should be understood, however, that the drawing is designed for the purpose of illustration only and not as a definition of the limits of the invention.

In the drawing, wherein similar reference characters denote similar elements throughout the several views:

FIG. 1 is a top view of the device for shaping and bending material.

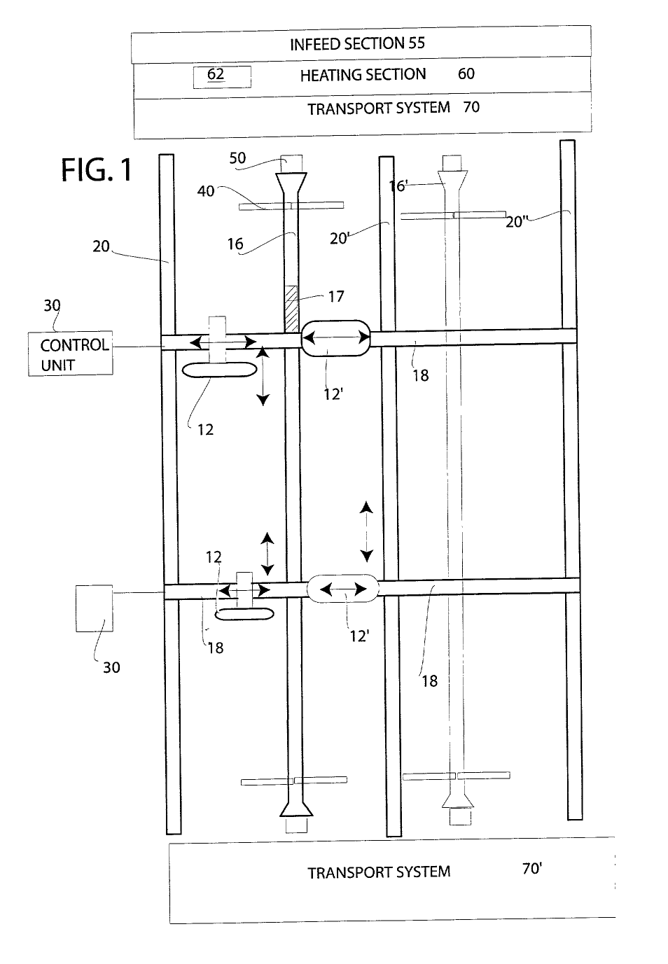

### DETAILED DESCRIPTION

Referring to the drawings, the FIG. shows a top view of the device 10 which comprises a plurality of outer bending units 12 and inner bending units 12′ for bending pipes 16. Outer bending units 12 and inner bending units 12′ are disposed on a carriage assembly 18 that is movable about tracks 20, 20′ and 20″. With this design, outer bending units 12 are adjustable longitudinally so that they can be spaced closer together while inner bending units 12′ can be spaced either closer together or farther apart.

The pipe can be gripped by gripping pliers 40 wherein the ends of these pipes can be expanded by 45° via the use of mandrels 50 inserting into the ends if the pipe to create an expanded section 16′ of the pipe. When pipes 16 are bent, to prevent deformation these pipes can also contain a support material 17 disposed inside of the pipes to help keep a uniform bending process.

During the bending process the pipes are first taken in through an infeed apparatus 55 which then transports these pipes to a heating section 60 which can heat the pipes using a plurality of infrared lights 62. Pipes 16 are next put into transport system 70 which then takes these pipes to be shaped by the device whereby these pipes are grabbed by gripping pliers 40. Once these pipes are shaped they are then put into transport system 70′ whereby these pipes are then transported away.

Accordingly, while at least one embodiment of the present invention has been shown and described, it is to be understood that many changes and modifications may be made thereunto without departing from the spirit and scope of the invention as defined in the appended claims.

What is claimed is:

1. A process for shaping and processing pipes, with a plurality of adjustable bending units comprising the following steps:
a) moving the plurality of units freely along the pipes; and
b) performing a plurality of simultaneous bending operations using the adjustable bending units.

2. The process according to claim 1, further comprising the steps of:
a) engaging two end sections of the pipes using one of the plurality of bending units; and
b) applying at least one additional bending unit to the pipe corresponding to a number of further bending operations planned.

3. The process as in claim 1, wherein said outer bending units move towards each other longitudinally wherein said inner bending units move apart from each other laterally.

4. The process as in claim 1, further comprising the steps of:
providing a plurality of profiled rollers; and
bending a piece of material using said plurality of profiled rollers.

5. The process as in claim 4, wherein said step of providing a plurality of profiled rollers includes providing profiled double rollers between a piece of material that requires bending.

6. The process as in claim 4, wherein said step of providing a plurality of profiled rollers includes at least two outer bending units having gripping pliers.

7. The process as in claim 6, wherein said gripping pliers are profiled.

8. The process as in claim 1, further comprising the step of:
pressing a plurality of sealing nipples axially into two end sections of a piece of pipe shaped material that are being held by said bending units or said gripping pliers.

9. The process as in claim 8 wherein said step of pressing said sealing nipples into said end sections comprises expanding said end sections by about 45□ to create a flange.

10. The process as in claim 1, further comprising the step of heating said material to bend said material.

11. The process as in claim 10, wherein said heating step is before said bending step.

12. The process as in claim 10, wherein said heating step is during said bending step.

13. The process as in claim 10, wherein said heating step is after said bending step.

14. The process as in claim 10, wherein said heating step includes heating the material into a thermoplastic range.

15. The process as in claim 10, wherein said heating step includes using a radiation heater.

16. The process as in claim 15, wherein said heating step includes using an infrared heater.

17. The process as in claim 10, said heating step includes channeling steam through a pipe section to heat the material.

18. The process as in claim 10, wherein said heating step includes using hot air to heat up the plastic pipe section.

19. The process as in claim 18, wherein said heating step includes pressurizing the hot air in the pipe section.

20. The process as in claim 19, wherein said hot air is left in said pipe section under pressure.

21. The process as in claim 20, further comprising the step of cooling the piece of material after the bending and heating operations have been completed.

22. The process as in claim 20, further comprising the step of forcing cold water through the pipe section for cooling purposes.

23. The process as in claim 1, further comprising the step of pressurizing the pipe section internally during the bending operation.

24. The process as in claim 1, wherein the cross section of the pipe section is stabilized during the bending operation via an insertion of a flexible core.

25. A device for shaping and processing pipes, by performing a plurality of simultaneous bending operations, the device comprising:
a) a plurality of bending units; and
b) at least one carriage assembly for supporting said plurality of bending units, wherein said carriage assembly is mobile and can move along the pipes during the shaping process.

26. The device as in claim 25, further comprising at least two adjacent tracks coupled to said carriage assembly.

27. The device as in claim 25, wherein said bending units further comprise a plurality of bending cores that have different bending raises and different groove sizes.

28. The device as in claim 25, wherein said bending units are designed as robots, wherein said robots are capable of removing a tool that is needed at any time from a magazine.

29. The device as in claim 25, further comprising a control unit, coupled to said bending units said control unit for controlling and setting a plurality of bending parameters for said pipes.

30. The device as in claim 29, wherein said plurality of bending units can be actuated to process a plurality of pipe sections at the same time, and wherein all of said processing units can be actuated to process one single pipe section at least approximately at the same time.

31. The device as in claim 25, further comprising a heating section and a separating unit wherein said at least one carriage assembly is disposed after said separating unit.

32. The device as in claim 31, wherein said at least one carriage assembly is a tandem transport carriage having two supports for the pipe section, and wherein said transport carriage is CNC controlled.

33. The device as in claim 32, wherein said transport carriage further comprises heat insulation facilities, to avoid cooling the heated pipe sections to be transported.

34. The device as in claim 33 wherein said transport carriage can move to at least one take-over position.

35. The device as in claim 34, further comprising gripping tools which are heat insulated, coolable and heatable.

36. The device as in claim 1, further comprising shaping tools configured as transfer units which are in position to pass each pipe section on to a buffer or transport system once the shaping process has been completed.

37. The apparatus as in claim 36, wherein said processing stations have double bending units.

38. The apparatus as in claim 37, wherein said double bending units are a variable distance away from each other and wherein said two bending units are located so that they can be swivelled in relation to each other.
